(19) United States
(12) Patent Application Publication
(10) Pub. No.: US 2009/0069186 A1
(43) Pub. Date: Mar. 12, 2009

(54) FORMULATIONS

(75) Inventors: Ian Malcolm Shirley, Bracknell (GB); Alexander Mark Heming, Bracknell (GB); Peter David Winn, Bracknell (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA LIMITED, Guildford, Surrey (GB)

(21) Appl. No.: 11/908,994

(22) PCT Filed: Mar. 10, 2006
(86) PCT No.: PCT/GB2006/000844

§ 371 Date: Apr. 28, 2008

(30) Foreign Application Priority Data
Mar. 18, 2005 (GB) 0505569.4

(51) Int. Cl. A01N 25/00; A01P 3/00; A01P 13/00

(52) U.S. Cl. 504/360; 424/405

(57) ABSTRACT

A dispersion comprising a discontinuous phase of solid particles or liquid droplets in a liquid continuous phase; a polymeric dispersant having a segment soluble in the continuous phase and a segment insoluble in the continuous phase; and a network around the solid particles or liquid droplets of the discontinuous phase formed by cross-linking of the polymeric dispersant; where the cross-linking is between segments that are soluble in the continuous phase.

This invention relates to particle dispersions and to emulsions and in particular to the use of reactive polymeric dispersants for the stabilisation of particle dispersions and emulsions.

Particle dispersions and emulsions are used widely in many applications and considerable effort is expended in producing stable formulations that will deliver the desired effects in use. Particle dispersions and emulsions are usually stabilised by surface active agents or surfactants that are physically adsorbed at the interface between the dispersed and continuous phases in order to maintain separation of the discrete dispersed bodies. Such physically adsorbed surfactants may however be displaced through competitive desorption by other surface active compounds or by conditions that stress the formulation, for example temperature cycling or electrolyte concentration. There is a constant need to develop options and means for improving the formulation robustness of dispersed systems.

A further example of a problem encountered in preparing robust formulations involves increase in size or shape of the particles of the dispersed phase. Some chemical compounds (in particular agrochemicals) may be slightly soluble in the liquid medium of the continuous phase. This may lead to creation of new crystals of the dispersed phase or to growth of the original crystals of the dispersed phase. Both these events may lead to crystals that are of a size or shape which is deleterious to the use of the formulated product. The amount of material of the dispersed phase that can be transported into and through the liquid continuous phase is known to be increased by the presence of surfactant which is not adsorbed to the interface between the dispersed and continuous phases. This process is known as Ostwald ripening; in emulsions rather than leading to crystals, it leads to an increase in droplet size.

U.S. Pat. No. 6,262,152, WO 02/100525 and WO 2004/052099 [the contents of each of which are hereby incorporated by reference] disclose that formulation robustness of certain dispersions or emulsions may be enhanced by chemically cross-linking polymeric dispersant molecules adsorbed on liquid droplets or solid particles that are dispersed in a continuous phase. These disclosures employ amphipathic polymers that are cross-linked through functional groups residing on polymer segments that are insoluble in the continuous phase.

The present invention provides an alternative means of enhancing the robustness of emulsions and particle dispersions by irreversibly binding a polymeric dispersant at the liquid/liquid or solid/liquid interface such that said dispersant cannot desorb. Surprisingly we have found that such polymeric dispersants can be cross-linked through functional groups residing on polymer segments that are soluble in the continuous phase.

Therefore the present invention provides a dispersion comprising a discontinuous phase of solid particles or liquid droplets in a liquid continuous phase; a polymeric dispersant having a segment soluble in the continuous phase and a segment insoluble in the continuous phase; and a network around the solid particles or liquid droplets of the discontinuous phase formed by cross-linking of the polymeric dispersant; where the cross-linking is between segments that are, soluble in the continuous phase.

Suitably, the solid particles or liquid droplets of the present invention have an average diameter of between 1000 μm (micrometers) and 0.1 μm; more suitably between 100 μm and 0.5 μm; and even more suitably between 5.0 μm and 1.0 μm.

The term ‘solid particles’ includes microcapsules, which may have reservoir or matrix structures. Matrix structures are ‘solid particles’. Reservoir structures have a solid shell with a hollow interior, generally containing a liquid in the interior.

Suitably the dispersion of the present invention is one where the continuous phase is aqueous-based; the term “aqueous-based” means a continuous phase that comprises more than 50 percent water by weight. Agrochemical formulations may contain organic solvents in the aqueous-based continuous phase. For example propylene glycol may be added as an anti-freeze agent.

In certain circumstances it is preferred that the continuous phase is non-aqueous based.

The nature of the material to be dispersed is not critical to the scope of the present invention and any solids or liquids suitable as dispersed phases may be used. The benefits of the present invention may however be of particular relevance to specific dispersed phase materials and applications. For example dispersions of the present invention will be of particular utility in formulations requiring mixtures of different dispersed materials or for which long term stability against aggregation, agglomeration or coalescence presents a problem.

Regarding emulsions of the present invention the liquid droplets of the dispersed phase will comprise a liquid that is immiscible with the liquid of the continuous phase and may contain further components. The further components may be liquids, they may be solids that have been dissolved in the liquid of the dispersed phase or they may be solids that are dispersed as particles within the liquid of the dispersed phase.

The present invention may be useful for a number of commercial products, including but not limited to, formulations of agrochemicals, biologically active compounds, coatings [such as paints and lacquers], colourings [such as inks, dyes and pigments], cosmetics [such as lip-sticks, foundations, nail polishes and sunscreens], flavourings, fragrances, magnetic and optical recording media [such as tapes and discs] and pharmaceuticals.

Dispersions of the present invention may be agrochemical dispersions having solid particles that comprise an agrochemical or liquid droplets that comprise an agrochemical, in which case the dispersed phase may comprise a bactericide, fertilizer or plant growth regulator or, in particular, a fungicide, herbicide or insecticide.

Therefore in a suitable aspect, the dispersion of the present invention is an agrochemical dispersion.

Agrochemical dispersions do not necessarily comprise an agrochemical active ingredient; they may simply comprise an adjuvant for use in conjunction with an agrochemical active ingredient. Amongst other functions the adjuvant may alter biological efficacy, improve rainfastness, reduce photodegradation or alter soil mobility.

Furthermore, there may be dispersed solid particles and liquid droplets present in the same continuous phase, where the solid particles may comprise one agrochemical active ingredient whilst the liquid droplets comprise another agrochemical active ingredient. An example of such a formulation is an aqueous-based suspoemulsion. It is a particular advantage of the present invention that in a suspoemulsion the same polymeric dispersant may be used to stabilise both the solid particles and liquid droplets against aggregation, flocculation, agglomeration or engulfment, even if in one instance it is cross-linked and in the other it is not. For example it may be that the polymeric dispersant on the solid particles is cross-linked but the polymeric dispersant on the liquid droplets is not or visa versa. The use of the same polymeric dispersant may avoid incompatibility problems. Likewise, it is possible to have more than one type of solid particle [or liquid droplet] dispersed in the continuous phase by the same polymeric dispersant, in order to avoid incompatibility problems.

The scope of the invention with regard to mixtures of solid particles and/or oil droplets of different materials is not limited to instances where all the dispersed bodies are stabilised with a polymeric dispersant of the present invention. For example a dispersion prepared in accordance with the present invention may additionally comprise solid particles or liquid droplets dispersed using conventional surfactants or dispersants. The skilled artisan will be aware of suitable conventional surfactants or dispersants for this purpose.

Any agrochemical that can be dispersed as solid particles or dissolved in an organic solvent immiscible with water or dispersed in an organic liquid immiscible with water may be used in this invention.

Examples of suitable agrochemicals include but are not limited to:

(a) herbicides such as fluazifop, mesotrione, fomesafen, tralkoxydim, napropamide, amitraz, propanil, cyprodanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfinuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron and metoxuron;
(b) fungicides such as azoxystrobin, trifloxystrobin, kresoxim methyl, famoxadone, metominostrobin, picoxystrobin, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, 8-(2,6-diethyl-4-methyl-phenyl)tetrahydropyrazolo[1,2-d][1,4,5]oxadiazepine-7,9-dione and 2,2,-dimethyl-propionic acid-8-(2,6-diethyl-4-methyl-phenyl)-9-oxo-1,2,4,5-tetrahydro-9H-pyrazolo[1,2-d][1,4,5]-oxadiazepine-7-yl ester; and
(c) insecticides such as abamectin, acephate, acetamiprid, acrinathrin, alanycarb, aldicarb, allethrin, alpha-cypermethrin, amitraz, asulam, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioresmethrin, bistrifluoron, borax, buprofezin, butoxycarboxim, cadusafos, carbaryl, carbofuran, chlorpropham, clothianidin, cyfluthrin, cyhalothrin, cyprmethrin, deltamethrin, diethofencarb, diflubenzuron, dinotefuran, emamectin, endosulfan, fenoxycarb, fenthion, fenvalerate, fipronil, halfenprox, heptachlor, hydramethylnon, imidacloprid, imiprothrin, isoprocarb, lambda cyhalothrin, methamidophos, methiocarb, methomyl, nitenpyram, omethoate, permethrin, pirimicarb, pirimiphos methyl, propoxur, tebufenozide, thiamethoxam, thiodicarb, triflumoron and xylylcarb.

The compositions and preparation methods of polymeric dispersants or surfactants are many and varied. A review of such materials is given in the text by Piirma, Polymeric Surfactants, Surfactant Science Series 42 (Marcel Dekker, New York, 1992). An important class of polymeric dispersants are those termed “amphipathic” or “amphiphilic”, which may be comb-shaped copolymers, that have pendant polymeric arms attached to a polymeric backbone, or block copolymers. The surface active properties of polymeric dispersants are determined by the chemical composition and relative sizes of the different polymer segments.

For example a block copolymeric surfactant for use in an aqueous system may have a segment of water soluble polymer such as polyethylene oxide adjoined to a segment of water insoluble polymer such as polypropylene oxide; whilst a comb-shaped copolymeric surfactant for use in an aqueous system may have segments of water soluble polymer such as polyethylene oxide as pendant arms adjoined to a segment of water insoluble polymer such as polymethyl methacrylate as the backbone.

The amount of polymer adsorbed at the interface is maximised when the polymeric dispersant has a high propensity to adsorb to the colloid surface but has little or no propensity to micellise or otherwise aggregate in the continuous phase.

A polymeric dispersant for use in the present invention may have a single segment which is soluble in the continuous phase, this segment providing the function of cross-linking as well as the function of colloid stabilisation. Alternatively, there may be more than one segment which is soluble in the continuous phase and one such segment may provide the function of cross-linking whilst another segment may provide the function of colloid stabilisation; in such a polymeric dispersant, the chemistries of the cross-linking segment and the colloid-stabilising segment may be the same but it is preferred that they are different.

Therefore, in a suitable aspect of the present invention, there is a dispersion as described above where the polymeric dispersant has a second segment soluble in the continuous phase and said second soluble segment is chemically different from the other soluble segment. When the chemistries are different, cross-linking may be achieved by a mechanism specific to the chemistry of the particular cross-linking segment; that is, the chemistry may be chosen such that there is no mechanism by which cross-linking of the colloid-stabilising segment may occur. When the chemistries of the cross-linking segment and the colloid-stabilising segment are similar, a low level of cross-linking of the colloid-stabilising segments is acceptable where this does not catastrophically affect colloidal stabilisation; particularly this will be the case when the resultant cross-linked structure enhances solvation of the segment in the continuous phase.

There are a number of polymer architectures whereby cross-linking of segments soluble in the continuous phase may be realised without affecting colloid stabilisation. For example, the following architectures are suitable for use with water as the liquid continuous phase:
A segment of water soluble cross-linkable polymer adjoined to a comb-shaped copolymer. In the comb-shaped copolymer the backbone is water insoluble and the pendant arms are water soluble; alternatively the backbone is water soluble and the pendant arms are water insoluble. The mechanism for cross-linking is then chosen so as to occur at the cross-linkable polymer segment and not at the water soluble pendant arms or water soluble backbone.
A water soluble segment adjoined to a water soluble cross-linkable segment adjoined to a water insoluble segment. The mechanism for cross-linking is then chosen so as not to occur at the first water soluble segment and cross-linking is restricted to the second water soluble segment, proximal to the water insoluble segment.
A water soluble segment adjoined to a water insoluble segment adjoined to a cross-linkable water soluble segment. The mechanism for cross-linking is then chosen so as to only occur at the cross-linkable water soluble segment.
A cross-linkable water soluble segment adjoined to a water insoluble segment. This could be achieved with a diblock copolymer or with a comb-shaped copolymer where the backbone is water insoluble and the pendant arms are water soluble or alternatively where the backbone is water soluble and the pendant arms are water insoluble. The mechanism for cross-linking is then chosen to give a water-swollen hydrogel around the solid particle or liquid droplet of the dispersed phase that provides a sufficient barrier to prevent coalescence, agglomeration, aggregation or other such events that would lead to poor formulation performance.

The above examples are given for the purpose of illustration only; those skilled in the art will be familiar with other architectures that may meet the criteria of cross-linking through water soluble segments and likewise will be able to adapt the above teaching to dispersions with a non-aqueous based continuous phase.

Amphipathic polymers for use in the present invention may be made by several approaches, chiefly by the coupling of preformed polymeric segments or polymerisation of monomers in a controlled or stepwise fashion. For example a block copolymeric dispersarit for use in an aqueous based continuous phase may be made (i) by the controlled stepwise polymerisation of firstly water insoluble and secondly water soluble monomers, or the reverse of this process; or (ii) by coupling together pre-formed water insoluble and water soluble polymeric segments. One skilled in the art will be aware of the various advantages and drawbacks of each of these approaches.

Suitably the polymeric dispersant is an amphipathic copolymer comprising a plurality of vinyl monomers which may be adjoined to a product of a condensation or ring-opening polymerisation.

Segments of the polymeric dispersant that are soluble in the continuous phase may comprise a monomer soluble in the continuous phase copolymerised with a monomer insoluble in the continuous phase provided that the overall composition is such that the segment is soluble in the continuous phase. For example, in a polymeric dispersant for use in an aqueous-based continuous phase a segment soluble in the continuous phase may comprise methacrylic acid copolymerised with methyl methacrylate provided that the ratio of methacrylic acid to methyl methacrylate is such that the segment is water soluble at the pH of use.

Further examples of vinyl monomers that enhance water solubility of a polymeric segment containing them are inter alia acrylamide and methacrylamide, acrylic and methacrylic acid, 2-acrylamido-2-methylpropane sulphonic acid, 2,3-dihydroxypropyl acrylate and methacrylate, 2-(dimethylamino)ethyl acrylate and methacrylate, itaconic acid, oligo- or poly-ethylene oxide mono-acrylate or -methacrylate, maleic acid, styrene sulfonic acid, sulfoethyl methacrylate, vinylpyridine and vinylpyrollidone.

Examples of vinyl monomers that decrease the water solubility of a polymeric segment containing them are inter alia methyl acrylate, methyl methacrylate and other alkyl esters of acrylic and methacrylic acid, phenyl acrylate, phenyl methacrylate and other aryl esters of acrylic acid and methacrylic acid, butadiene, styrene and alkyl substituted styrenes, vinyl acetate and other alkyl or aryl esters of vinyl alcohol, vinyl chloride or vinylidine dichloride.

Controlled stepwise polymerisation may be carried out by various methods known in the art. These methods are often referred to as “living” or “controlled” polymerisations and give finer control over molecular weight and polydispersity index (the ratio of weight average to number average molecular weight) than more conventional techniques. Examples of these methods can be found in the scientific literature and include anionic and cationic polymerisation and group transfer polymerisation, which require demanding reaction conditions and very pure reagents, and living free-radical polymerisation, which generally requires less demanding conditions.

Various methods of living free-radical polymerisation are known. These include use of disulphide or tetraphenylethane “iniferters”, nitroxide chain transfer agents, cobalt complex chain transfer agents, atom transfer radical polymerisation using transition metal complexes and radical addition-fragmentation transfer polymerisation using sulphur containing organic compounds.

Comb-shaped copolymers need not be prepared by a controlled stepwise reaction so long as the backbone is a single copolymeric segment; if it is more than one segment then it may be prepared as described above for block copolymers. Comb-shaped copolymers may be prepared by (i) graft polymerisation of the pendant arm segments from the backbone segment; (ii) coupling preformed pendant arm segments to a backbone segment; or (iii) carrying out a statistical or random copolymerisation of appropriate monomers for the backbone segment with macro-monomers, which are preformed pendant arm segments with an appropriate polymerisable moiety on one end group. An example of a macro-monomer suitable for preparing a comb-shaped copolymer with water soluble pendant arms is mono-methoxy-polyethylene glycol-mono-methacrylate.

The preferred preparative method for any given composition will depend on the nature and properties of the reagents. For example, reactivity ratios between certain monomers may limit the scope of the copolymeric architecture that can be obtained. Molecular weight of the polymeric dispersant is also an important factor. If the molecular weight is too high the polymer will be excessively viscous in solution and difficult to use, if it is too low it will not have a homogenous chemical composition and if it is too broadly distributed it will be difficult to predict its behaviour. One skilled in the art will be able to select the appropriate materials and conditions to prepare the desired copolymer structure of an appropriate molecular weight.

The polymeric dispersants for use in this invention are amphipathic surface active molecules which physically adsorb at interfaces between immiscible materials. Prior to cross-linking they are used in a process suitable for the preparation of the desired dispersion. For example solid particles or an immiscible liquid may be dispersed into a liquid continuous phase using a colloid or attritor mill, triple roll mill, high speed rotor-stator device or high pressure homogeniser. One skilled in the art can easily select the appropriate method for preparing the desired dispersion and for achieving the desired size of solid particles or liquid droplets.

Whilst cross-linking may have the effect of slightly increasing the overall particle or droplet size in the dispersion this effect is generally small if it exists at all. Surprisingly, we have found that even after cross-linking the average particle or droplet size in the dispersion normally remains well within preferred limits, for example below about 10 microns and more particularly below about 5 microns.

Prior to cross-linking, the ratio (A:B) by weight of the polymeric dispersant [A] to the suspended solid or oil droplet [B] is suitably from 1 part of A to 400 parts of B (1:400) to 1 part of A to 5 parts of B (1:5), for example from 1 part of A to 200 parts of B (1:200) to 1 part of A per 10 parts of B (1:10). A more suitable range is from 1:10 to 1:100, for example from 1:20 to 1:75. A ratio of about 1:50 is particularly suitable.

There is a clear economic advantage in using the minimum necessary quantity of polymeric dispersant in the formulation. Furthermore we have found that using the minimum necessary quantity may minimise unproductive and potentially deleterious cross-linking of the polymeric dispersant by reaction of a cross-linking segment in the body of the aqueous phase as opposed to on the surface of a particle or droplet.

In accordance with the present invention certain reactive moieties located within the polymeric dispersant in a polymeric segment that is soluble in the liquid continuous phase are cross-linked to irreversibly bind the polymeric dispersant at the interface between a solid particle or oil droplet and the continuous phase. This may involve reaction of the reactive moieties with a cross-linking substance added to the continuous phase either before or after preparation of the dispersion. In the case of emulsions a cross-linking substance may be added to the discontinuous liquid phase before preparation of the emulsion. The reactive moieties may also react with each other or with different functional groups contained within segments of the polymeric dispersants that are soluble in the continuous phase. Any of the above cross-linking reactions may happen spontaneously or be triggered by a change in the environment of the dispersion such as but not limited to a change in pH or temperature. Appropriate reactive moieties and cross-linking substances should be selected to ensure that premature cross-linking, or side reactions such as hydrolysis, are minimised prior to completing preparation of the dispersion and one skilled in the art would easily be able to do this.

The cross-linking reaction may be any facile chemical reaction that creates a strong bond, be it covalent or non-covalent, between reactive moieties located in the polymeric dispersant in segments that are soluble in the liquid continuous phase. Suitable reactions are ones that do not require conditions such as high temperature which would prove deleterious to the colloid stability of the dispersion or to the chemical stability of any component of the dispersion. In the case where a cross-linking substance is employed said substance must clearly have a functionality of at least two reactive groups, but may have many more. Examples of functional groups suitable for reactive moieties in the polymeric dispersant or in a cross-linking substance are primary amines which may react with aldehydes or ketones; primary or secondary amines which may react with acetoacetoxy groups, anhydrides, aziridines, carboxylic acids, carboxylic acid halides, epoxides, imines, isocyanates, isothiocyanates, N-methylol groups and vinyl groups; primary, secondary or tertiary amines which may react with alkyl or aryl halides; hydroxyl groups which may react with anhydrides, aziridines, carboxylic acids, carboxylic acid halides, epoxides, imines, isocyanates, isothiocyanates or N-methylol groups; hydroxyl groups which may undergo transesterification reactions with labile esters; thiol groups which may react with acetoacetoxy groups, anhydrides, aziridines, carboxylic acids, epoxides, imines, isocyanates, isothiocyanates and N-methylol groups or may be reduced to disulphides; carboxylic acids which may react with primary or secondary amines, aziridines, carbodiimides, epoxides, hydroxyl groups, imines, isocyanates, isothiocyanates, N-methylol and thiol groups; carboxylic acid halides or acid anhydrides which may react with primary or secondary amines, hydroxyl, N-methylol and thiol groups; silicon based groups such as siloxanes which react with themselves in the presence of water; aldehyde or ketone groups which may react with primary or secondary amines or with hydrazines, or vinyl groups which react with primary or secondary amines or with free-radicals.

Examples of non-covalent bonding which may be employed for cross-linking include the use of di- or tri-valent metal ions such as calcium, magnesium or aluminium with carboxylic acid groups; transition metals such as copper, silver, nickel or iron with appropriate ligands; or strong hydrogen bonding such as boric acid with hydroxyl groups, biguanidines with carboxylic acids or multiple hydrogen bonding such as that which occurs between proteins.

For some reactions catalysts may be employed to improve the speed at which cross-linking occurs. Examples of catalysts that may be employed are N-hydroxysuccinimide to assist in the reaction of amines with carboxylic acids, carbodiimides to assist in the reaction of hydroxyl groups with carboxylic acids, acid conditions to assist in the reaction of epoxides or tertiary amines to assist the reaction of isocyanates. The preceding examples are not intended to limit the scope of the invention with regards to the chemistry employed to cross-link the polymeric dispersant. The only stipulation is that the functional groups undergoing cross-linking reactions are located in polymer segments that are soluble in the liquid continuous phase of the dispersion.

Suitably the cross-linking functional groups present in a segment of the polymeric dispersant that is soluble in the liquid continuous phase are carboxylic acid and they are cross-linked by a cross-linking substance which carries two or more aziridine functional groups.

The present invention is illustrated by the following non-limiting Examples.

### EXAMPLES

The following Examples illustrate the preparation of amphipathic polymeric dispersants suitable for the preparation of dispersions of agrochemicals in water and which may be cross-linked through functional groups located in water soluble polymer segments.

The materials used and their abbreviations given in the Tables below were: n-butyl acrylate [BA] (from Sigma-Aldrich); 2,3-dihydroxypropyl methacrylate [DHPMA] (from Rohm GMBH); 2-(dimethylamino)ethyl methacrylate [DMAEMA] (from Sigma-Aldrich); methacrylic acid [MAA] (from Sigma-Aldrich); methyl acrylate [MA] (from Sigma-Aldrich); methyl methacrylate [MMA] (from Sigma-Aldrich); N-hydroxysuccinimidomethacrylate [NHSMA] (prepared according to the method of Batz et al in Angew. Chem. Int. Ed. 1972, 11, 1103); mono-methoxy poly(ethylene glycol) mono-methacrylate (with a molecular weight of either approximately 1000 g/mole [PEGMA 1] or 2000 g/mol [PEGMA2], sold as BISOMER™ S10W and S20W respectively by Degussa, UK, and freeze dried to remove water). All quantities are given in parts by weight unless otherwise noted.

### Examples A1-A22

These polymeric dispersants were prepared by atom transfer radical polymerisation according to the method of Haddleton et al. (Macromolecules, 1997, 30, 2190-2193). Discrete polymer segments were built up by sequential (co)monomer addition; the compositions of the (co)monomer batches used are given in Table 1 below.

The initiator for atom transfer radical polymerisation was added as part of the first batch and is noted in Table 1. The initiator used was either ethyl-2-bromo-iso-butyrate [E2BiB] (from Sigma-Aldrich), a poly(ethylene glycol) derived macro-initiator [PEG-Br] with a molecular weight of approximately 2000 g/mole, prepared according to the method of Jankova et al. (Macromolecules, 1998, 31, 538-541) or a bis-phenol derived dibromide [BPDB] made according to the following procedure.

### Preparation of 4,4′-isopropylidene diphenyl bis-2-bromo-2-methylpropionate

A slurry of 1 part of 4,4′-isopropylidene diphenol in 8.7 parts of toluene was deoxygenated by sparging with dry nitrogen gas for 1 hour. 1.06 parts of triethylamine were added to the slurry resulting in a clear solution. The reaction mixture was cooled to 0° C. before 2.4 parts of 2-bromoisobutyryl bromide were added drop-wise over 90 minutes and then the reaction mixture left to stir for 24 hours at 20° C. The resultant precipitate was removed by filtration and the remaining light brown solution reduced under vacuum to give a brown solid, which was recrystallised from methanol to yield the product as white flakes.

After polymerization was completed the polymers were isolated by methods common in the art. In the cases of A1-A15, the solutions were passed through a column of activated basic alumina to remove copper salts and isolated by precipitation into petroleum ether (60-80° C.). In the cases of A16-A18, the polymer solutions were treated with aqueous ammonium hydroxide (1.2 molar equivalents with respect to the NHSMA monomer) to deprotect the carboxylic acid groups and the polymer isolated by precipitation into acetone at −79° C. In the cases of A19-A22, the polymer solutions were passed through a column of activated basic alumina to remove copper salts and the solvent removed under vacuum. The polymer was subsequently dissolved into water at pH 10 (addition of NaOH) and stirred for 24 hours at 20° C. to deprotect the carboxylic acid groups.

TABLE 1

| Ex. | Initiator | Batch 1 | Batch 2 | Solvent |
|---|---|---|---|---|
| A1 | E2BiB 0.3 parts | PEGMA1 17.0 parts | DMAEMA 4.2 parts | Toluene 67 parts |
| | | MMA 11.4 parts | | |
| A2 | E2BiB 0.3 parts | PEGMA1 18.4 parts | DMAEMA 2.5 parts | Toluene 67 parts |
| | | MMA 11.8 parts | | |
| A3 | E2BiB 0.3 parts | PEGMA1 17.3 parts | DHPMA 2.6 parts | Toluene 67 parts |
| | | MMA 12.8 parts | | |
| A4 | PEG-Br 10 parts | DMAEMA 7.9 | MMA 15.2 parts | Toluene 67 parts |
| | | parts | | |
| A5 | PEG-Br 7.7 parts | DMAEMA 13.1 | MMA 12.5 parts | Toluene 67 parts |
| | | parts | | |
| A6 | PEG-Br 9 parts | DHPMA 9 parts | MMA 15.3 parts | Toluene 67 parts |
| A7 | PEG-Br 6.9 parts | DHPMA 13.7 parts | MMA 12.7 parts | Toluene 67 parts |
| A8 | PEG-Br 16.6 parts | MMA 11.1 parts | DMAEMA 5.6 parts | Toluene 67 parts |
| A9 | PEG-Br 9.1 parts | MMA 13.5 parts | DMAEMA 10.7 parts | Toluene 67 parts |
| A10 | PEG-Br 16.5 parts | MMA 11 parts | DHPMA 5.6 parts | Toluene 67 parts |
| A11 | PEG-Br 14 parts | MMA 9.3 parts | DHPMA 9.8 parts | Toluene 67 parts |
| A12 | E2BiB 0.8 parts | MMA 8.8 parts | DMAEMA 23.8 parts | Toluene 67 parts |
| A13 | E2BiB 0.9 parts | MMA 13.6 parts | DHPMA 18.9 parts | Toluene 67 parts |
| A14 | E2BiB 0.8 parts | MMA 10.3 parts | DMAEMA 16.2 parts | Toluene 67 parts |
| | | | DHPMA 6 parts | |
| A15 | E2BiB 0.9 parts | MMA 14.2 parts | DMAEMA 13.3 parts | Toluene 67 parts |
| | | | DHPMA 4.9 parts | |
| A16 | E2BiB 0.7 parts | MMA 10.6 parts | NHSMA 19.4 parts | DMSO 70 parts |
| A17 | E2BiB 0.6 parts | MMA 11.5 parts | NHSMA 31.6 parts | DMSO 70 parts |
| A18 | E2BiB 0.7 parts | MMA 7.3 parts | NHSMA 20.1 parts | DMSO 70 parts |
| A19 | BPDB 0.8 parts | PEGMA2 21 parts | NHSMA 3 parts | Toluene 69 parts |
| | | MMA 7 parts | | |
| A20 | BPDB 0.8 parts | PEGMA2 20 parts | NHSMA 4.5 parts | Toluene 69 parts |
| | | MMA 6 parts | | |
| A21 | BPDB 0.8 parts | PEGMA1 22.3 parts | NHSMA 1.9 parts | Toluene 69 parts |
| | | MMA 6.3 parts | | |
| A22 | BPDB 0.8 parts | PEGMA1 21 parts | NHSMA 3.6 parts | Toluene 69 parts |
| | | MMA 5.9 parts | | |

### Examples A23-30

These polymeric dispersants were prepared by first using catalytic chain transfer polymerization to prepare macro-monomer “arm” segments which were secondly copolymerised along with monomers to form a “backbone” segment. The chain transfer catalyst was bis(methanol)-bis(dimethylglyoximate-difluoroboron) cobalt(II) [COBF] as described by Haddleton et al. in Journal of Polymer Science Part A—Polymer Chemistry 2001, 39 (14), 2378. Polymerisation initiators azobis(2,4-dimethylvaleronitrile [V-65], azobis(2-isopropyl-4,5-dihydro-1H-imidazole dihydrochloride) [VA-044] and dimethyl-2,2′-azobis(2-methylpropionate) [V601] (all from Wako GMBH, Neuss, Del.) were used.

### Example A23

To a jacketed reactor equipped with a thermocouple, reflux condenser, overhead stirrer, and a nitrogen inlet to maintain an inert atmosphere throughout the course of the reaction, portion 1 was added, deoxygenated by sparging with nitrogen gas for 1 hr and then heated to reflux (92° C.). The previously deoxygenated Portion 2 was added to the reactor and the vessel that contained Portion 2 was rinsed with the deoxygenated Portion 3 which was also added to the reactor. The deoxygenated Portions 4 and 5 were added simultaneously to the reactor using two flow control pumps whilst the reaction mixture was maintained at reflux. The first 52.9% of Portion 4 was added over 90 min and the remaining 47.1% was added over 240 min. With Portion 5, the first 67.5% was added over 120 min and the remaining 32.5% was added over 120 min. Following the complete addition of Portions 4 and 5, the reaction mixture was maintained at reflux for a further 45 min before cooling at ambient temperature. The solvents were removed under vacuum to yield the product as a viscous, yellow/orange oil.

| | | | |
|---|---|---|---|
| Portion 1 | DMAEMA | 202.5 | parts |
| | Iso-propanol | 259.8 | parts |
| Portion 2 | Iso-propanol | 18.8 | parts |
| | Methyl ethyl ketone | 8.0 | parts |
| | CoBF | 0.0082 | parts |
| | V-65 | 0.2 | parts |
| Portion 3 | Iso-propanol | 15.7 | parts |
| Portion 4 | Iso-propanol | 56.1 | parts |
| | Methyl ethyl ketone | 24.1 | parts |
| | CoBF | 0.0168 | parts |
| | V-65 | 2.2 | parts |
| Portion 5 | DMAEMA | 182.5 | parts |

### Example A24

To a jacketed reactor equipped with a thermocouple, reflux condenser, overhead stirrer, and a nitrogen inlet to maintain an inert atmosphere throughout the course of the reaction, Portion 1 was added, deoxygenated by sparging with nitrogen gas for 2 hours and then heated to 55° C. Portion 2 was added and the previously deoxygenated portion 3 fed into the aqueous solution using a flow control pump at a rate of 8.5 ml/min over 53 minutes. The reaction was held at 55° C. for a further 2 hours before the solvents were removed under vacuum to yield the product as a white solid.

| | | | |
|---|---|---|---|
| Portion 1 | Deionised water | 954 | parts |
| | CoBF | 0.032 | parts |
| Portion 2 | VA-044 | 1.71 | parts |
| Portion 3 | MAA | 450 | parts |
| | CoBF | 0.021 | parts |

### Example A25

To a jacketed reactor equipped with a thermocouple, reflux condenser, overhead stirrer, and a nitrogen inlet to maintain an inert atmosphere throughout the course of the reaction, portion 1 was added, deoxygenated by sparging with nitrogen gas for 1 hour and then heated to reflux (87° C.). The previously deoxygenated Portion 2 was added to the reactor and the vessel that contained Portion 2 was rinsed with the deoxygenated Portion 3 which was also added to the reactor. The deoxygenated Portions 4 and 5 were added simultaneously to the reactor using two flow control pumps whilst the reaction mixture was maintained at reflux. The first 54.8% of Portion 4 was added over 90 min and the remaining 45.2% was added over 240 min. With Portion 5, the first 67% was added over 120 minutes and the remaining 33% was added over 120 minutes. Following the complete addition of Portions 4 and 5, the reaction mixture was maintained at reflux for a further 45 minutes before cooling at ambient temperature. The solvents were removed under vacuum to yield the product as a white solid.

| | | | |
|---|---|---|---|
| Portion 1 | MMA | 312.7 | parts |
| | MAA | 176.3 | parts |
| | Iso-propanol | 627.4 | parts |
| Portion 2 | Methyl ethyl ketone | 19.9 | parts |
| | Iso-propanol | 49.9 | parts |
| | CoBF | 0.0456 | parts |
| | V-65 | 0.5 | parts |
| Portion 3 | Iso-propanol | 41.3 | parts |
| Portion 4 | Methyl ethyl ketone | 59.5 | parts |
| | Iso-propanol | 148.8 | parts |
| | CoBF | 0.0913 | parts |
| | V-65 | 5.5 | parts |
| Portion 5 | MMA | 199.9 | parts |
| | MAA | 264.5 | parts |

### Examples A26-A30

The preparation of comb-shaped polymeric dispersants using the macro-monomers prepared by catalytic chain transfer polymerization in Examples A23-A25 is shown in Table 2. In each preparation the initiator, monomer and macro-monomer were dissolved in the solvents in a sealed tube fitted with nitrogen inlet, rubber septum and magnetic stirrer bar. The solutions were de-oxygenated by sparging with nitrogen gas via a needle for 30 minutes. The solutions were subsequently heated to 70° C. for 72 hours with stirring. In the cases of A26-A28 the polymers were isolated by removing the solvent under vacuum. In the cases of A29 and A30 the polymers were isolated by precipitation in dichloromethane.

TABLE 2

| Ex. | Initiator | Monomers | Macro-monomer | Solvent |
|---|---|---|---|---|
| A26 | V-601 0.1 parts | BA 9.6 parts | A23 13.4 parts | Isopropanol |
| | | | | 76.8 parts |
| A27 | V-601 0.1 parts | BA 5.6 parts | A23 17.4 parts | Isopropanol |
| | | | | 76.8 parts |
| A28 | V-601 0.1 parts | MA 6.8 parts | A23 16.2 parts | Isopropanol |
| | | | | 76.8 parts |
| A29 | V-601 0.1 parts | BA 2.2 parts | A25 18.1 parts | Isopropanol |
| | | | | 58.7 parts |
| | | | | Water |
| | | | | 18.1 parts |
| A30 | V-601 0.1 parts | BA 12.1 parts | A24 11parts | Isopropanol |
| | | | | 65.9 parts |
| | | | | Water |
| | | | | 11 parts |

### Examples B1-B27

The Examples in Table 3 illustrate the use of amphipathic polymeric dispersants in the preparation of aqueous suspensions of an agrochemical active ingredient.

Dispersions were prepared by taking 1 part of a polymeric dispersant [as prepared in one of Examples A1-A30 above] and 0.1 parts of a nonionic wetting agent (SYNPERONIC™ A7 from Uniqema Ltd) in 48.9 parts deionised water and adding 50 parts chlorothalonil (2,4,5,6-tetrachloro-1,3-benzenedicarbonitrile). Zirconia milling beads were added and the dispersion mechanically shaken for 30 minutes. Each dispersion was assessed by measuring particle size with a Malvern Instruments' Mastersizer™ 2000 laser light scattering apparatus, by examining the physical appearance and by looking for flocculation using a light microscope; the volume median size is tabulated for each sample in Table 3 below.

TABLE 3

| | | Par- | |
|---|---|---|---|
| | | ticle | |
| | | size | |
| Ex. | Polymer | (um) | Appearance |
| B1 | From Example A1 | 1.9 | Fluid dispersion with no flocculation |
| B2 | From Example A2 | 1.7 | Fluid dispersion with no flocculation |
| B3 | From Example A3 | 1.7 | Fluid dispersion with no flocculation |
| B4 | From Example A4 | 1.6 | Fluid dispersion with no flocculation |
| B5 | From Example A5 | 1.9 | Fluid dispersion with no flocculation |
| B6 | From Example A6 | 1.7 | Fluid dispersion with no flocculation |
| B7 | From Example A7 | 1.6 | Fluid dispersion with no flocculation |
| B8 | From Example A8 | 1.8 | Fluid dispersion with no flocculation |
| B9 | From Example A9 | 1.5 | Fluid dispersion with no flocculation |
| B10 | From Example A10 | 1.8 | Fluid dispersion with no flocculation |
| B11 | From Example A11 | 1.6 | Fluid dispersion with no flocculation |
| B12 | From Example A12 | 1.2 | Fluid dispersion with no flocculation |
| B13 | From Example A13 | 1.8 | Fluid dispersion with no flocculation |
| B14 | From Example A14 | 1.6 | Fluid dispersion with no flocculation |
| B15 | From Example A15 | 1.4 | Fluid dispersion with no flocculation |
| B16 | From Example A16 | 5.5 | Fluid dispersion with no flocculation |
| B17 | From Example A17 | 1.9 | Fluid dispersion with no flocculation |
| B18 | From Example A18 | 4.9 | Fluid dispersion with no flocculation |
| B19 | From Example A19 | 1.0 | Fluid dispersion with no flocculation |
| B20 | From Example A20 | 4.9 | Fluid dispersion with no flocculation |
| B21 | From Example A21 | 1.0 | Fluid dispersion with no flocculation |
| B22 | From Example A22 | 1.1 | Fluid dispersion with no flocculation |
| B23 | From Example A26 | 1.3 | Fluid dispersion with no flocculation |
| B24 | From Example A27 | 1.4 | Fluid dispersion with no flocculation |
| B25 | From Example A28 | 2.8 | Fluid dispersion with no flocculation |
| B26 | From Example A29 | 2.5 | Fluid dispersion with no flocculation |
| B27 | From Example A30 | 1.9 | Fluid dispersion with no flocculation |

### Examples C1-C14

These Examples demonstrate that cross-linking polymeric dispersants [via reactive moieties located in a polymer segment that is soluble in the continuous phase] leads to more stable dispersions, in which the dispersant is more difficult to displace from the surface of the solid particles, than when the same polymeric dispersant is used without cross-linking.

Solutions of cross-linking compounds were added to the dispersions from Examples B. In the case of C1, 1 part of a solution of bis-(iodoethoxy)ethane [BIEE] (of Sigma Aldrich) in acetone (1 part to 9 parts) was added to 9 parts of the dispersion at pH 9 and, in the cases of C2-C14, 1 part of a solution of trifunctional aziridine cross-linker in water (1 part to 9 parts) was added to 9 parts of the dispersion at pH 7. The trifunctional aziridines used were CX-100 (from NeoResins, Waalwijk, NL) and XAMA-2 (from Flevo Chemie, Harderwijk, NL). The dispersions were then agitated on a roller-bed at 20° C. for 16 hours before they were diluted with deionised water (1 part dispersion to 9 parts water) and acetone added to cause desorption of the stabilizing polymer. Table 4 shows the comparisons between tests where the same quantity of acetone has been added to two dispersions; one to which cross-linker has been added, as described above, and one to which no cross-linker has been added.

TABLE 4

| | | | Cross-linker | Cross-linker |
|---|---|---|---|---|
| Ex. | Dispersion | Cross-linker | added | not added |
| C1 | From B12 | BIEE | Fluid dispersion | Flocculated particles |
| C2 | From B16 | CX-100 | Fluid dispersion | Flocculated particles |
| C3 | From B17 | CX-100 | Fluid dispersion | Flocculated particles |
| C4 | From B17 | XAMA-2 | Fluid dispersion | Flocculated particles |
| C5 | From B18 | XAMA-2 | Fluid dispersion | Flocculated particles |
| C6 | From B19 | CX-100 | Fluid dispersion | Flocculated particles |
| C7 | From B19 | XAMA-2 | Fluid dispersion | Flocculated particles |
| C8 | From B20 | CX-100 | Fluid dispersion | Flocculated particles |
| C9 | From B20 | XAMA-2 | Fluid dispersion | Flocculated particles |
| C10 | From B21 | XAMA-2 | Fluid dispersion | Flocculated particles |
| C11 | From B22 | XAMA-2 | Fluid dispersion | Flocculated particles |
| C12 | From B26 | CX-100 | Fluid dispersion | Flocculated particles |
| C13 | From B26 | XAMA-2 | Fluid dispersion | Flocculated particles |
| C14 | From B27 | XAMA-2 | Fluid dispersion | Flocculated particles |

1. A dispersion comprising a discontinuous phase of solid particles or liquid droplets in a liquid continuous phase; a polymeric dispersant having a segment soluble in the continuous phase and a segment insoluble in the continuous phase; and a network around the solid particles or liquid droplets of the discontinuous phase formed by cross-linking of the polymeric dispersant; where the cross-linking is between segments that are soluble in the continuous phase.

2. A dispersion as claimed in claim 1 where the polymeric dispersant has a second segment soluble in the continuous phase and said second soluble segment is chemically different from the soluble segment of claim 1.

3. A dispersion as claimed in claim 1 or claim 2 where the continuous phase is aqueous-based.

4. A dispersion as claimed in claim 1, 2 or 3 where the dispersion is an agrochemical dispersion.

5. A dispersion as claimed in claim 4 where the discontinuous phase is solid particles comprising an agrochemical.

6. A dispersion as claimed in claim 4 where the discontinuous phase is liquid droplets comprising an agrochemical.
